(19) United States
(12) Patent Application Publication
(10) Pub. No.: US 2017/0253805 A1
(43) Pub. Date: Sep. 7, 2017

(54) METHOD FOR MODIFYING BIOBASED MATERIALS AND THE RESULTING COMPOSITIONS

(71) Applicant: GENAREX FD LLC, ALPHARETTA, GA (US)

(72) Inventors: Jeffrey J. Cernohous, Hudson, WI (US); Brandon J. Cernohous, Hudson, WI (US); David J. Winsness, Alpharetta, GA (US); Robert W. Montgomery, III, Lowell, MA (US)

(73) Assignee: GENAREX FD LLC, ALPHARETTA, GA (US)

(21) Appl. No.: 15/501,684

(22) PCT Filed: Aug. 4, 2015
(86) PCT No.: PCT/US15/43611

§ 371 Date: Feb. 3, 2017

Related U.S. Application Data
(60) Provisional application No. 62/033,005, filed on Aug. 4, 2014.

(51) Int. Cl. C10B 53/02; C10B 57/06; C08K 11/00

(52) U.S. Cl. CPC C10B 53/02; C08K 11/00; C10B 57/06

(57) ABSTRACT

A method of modifying a biobased feedstock derived from agricultural resources and specifically from the non-distillate products of fermentation-derived renewable fuel and distilled spirit processes. The pyrolytic modification of biobased feedstocks results in materials that are thermally stable and better suited for subsequent melt processing in a polymer matrix.

### PRIORITY INFORMATION

This application is a U.S. National Stage of International Application Number PCT/US2015/043611, filed Aug. 4, 2015, which claims the benefit of U.S. Provisional Application filed Aug. 4, 2014, which is fully incorporated herein by reference.

### TECHNICAL FIELD

This disclosure is directed to a method for modifying a biobased feedstock generated as a co-product in fermentation-derived renewable fuel and distilled spirit production processes that utilize grain-based crops. The modification of the biobased feedstock results in a composition that is well suited for subsequent melt processing with a polymer matrix.

### BACKGROUND

The production of fermentation-derived renewable fuels or distilled spirits from grain-based agricultural materials often creates co-products that are generally sold as feed or burned or gasified for use as an energy source. The co-products are characterized as biobased feedstocks that result from the fermentation of grains. There have been various attempts to recover and refine such biobased feedstocks for uses that generate a greater value for the feedstock on a per pound basis. For example, distillers dried grains with solubles (“DDGS”) have been placed in various plastics as fillers. However, such applications can be problematic with respect to achieving acceptable physical characteristics in the resulting composite materials.

One particular biobased feedstock is derived by distilling fermented grain-based material to produce a distillate fraction (such as ethanol or butanol) and a bottoms fraction, which is often referred to as whole stillage. The whole stillage is comprised of water and all of the parts of the fermented grain-based material that were not recovered in the distillate fraction. For corn-based ethanol processes, the whole stillage may comprise non-fermented starch and other carbohydrates, hemicellulose, corn hull, corn protein, corn fiber, corn oil, and ash. The whole stillage is typically subjected to a press or centrifugation process to separate the coarse solids from the liquid. The liquid fraction is commonly referred to as distillers solubles or thin stillage. Thin stillage is frequently concentrated in an evaporator to become condensed distillers solubles, often referred to as “CDS”, which is also commonly referred to as syrup. The coarse solids, or wet cake, collected from the centrifuge or press are known as wet distillers grains. Drying the wet distillers grains produces dried distillers grains or “DDG.” The wet distillers grains can be combined with the CDS to form what is commonly referred to as wet distillers grains with solubles, which can then be dried to form DDGS compounds. The industry continues to seek opportunities to place such materials in higher value products and applications.

### SUMMARY

This disclosure is directed at modifying a biobased feedstock derived from agricultural grains and specifically from the co-products of fermentation-derived renewable fuel or distilled spirit processes. More particularly, the pyrolytic modification of biobased feedstocks results in materials that are thermally stable and better suited for subsequent melt processing in a polymer matrix.

The biobased feedstock is generally the thin stillage resulting from grain-based ethanol and distilled spirit production facilities. This thin stillage, upon additional evaporative processing that can include drying, may yield a biobased feedstock in concentrated fluid, powder or granular form that is further modified in accordance with this disclosure. In certain embodiments, the biobased feedstock is pyrolytically modified to remove at least a portion of thermally labile components from the biobased feedstock to form a pyrolyzed biobased feedstock. Pyrolytic modification involves the rapid heating of the biobased feedstock to elevated temperatures over a relatively limited period of time. The resulting pyrolyzed material is thermally stable at temperatures typically employed in the melt processing of polymers and composite materials.

In some embodiments, the pyrolyzed biobased feedstock may be combined with a polymer matrix and other optional additives or adjuvants during melt processing to create a composite. The thermal stability of the pyrolyzed biobased feedstock enables such melt processing without adverse consequence to the melt or the finished article. Additionally, in certain embodiments, the resulting composite may have enhanced physical properties such as tensile strength, flexural modulus, impact strength or combinations thereof.

The following terms used in this disclosure are defined as follows:

“Biobased feedstock” means the non-distillate products derived from the fermentation of grains, such as distillers solubles, for example.

“Composite” means a mixture of a polymeric material and a biobased feedstock or pyrolyzed biobased feedstock along with other optional additives and adjuvants.

“Degradation onset temperature” means the temperature at which a material (in this case the biobased component of a composite) begins to break down and decompose. This temperature may be represented by the point of inflection triggering mass loss in thermogravimetric analysis (TGA).

“Melt Processable Composition” means a formulation that is melt processed, typically at elevated temperatures, by means of a conventional polymer processing technique such as extrusion or injection molding as examples.

“Melt Processing Techniques” means extrusion, injection molding, blow molding, or rotomolding batch mixing.

“Polymer Matrix” means a melt processable polymeric material or resin, e.g., a thermoplastic.

“Pyrolytic Modification” means the rapid heating of the biobased feedstock for the intentional removal of thermally labile components. Such heating may optionally occur in air, an inert gas, or under vacuum.

“Thermally labile” means components, such as inorganic compounds, organic compounds or polymers that decompose and/or outgas at temperatures below conventional polymer melt processing temperatures.

“Thermally stable” means a material's ability to withstand conventional melt processing temperatures without a significant loss of mass due to thermal degradation.

The disclosure may be understood more readily by reference to the following drawing and the detailed description of the various features described therein.

### DESCRIPTION OF THE DRAWING

FIG. 1 is a chart of a thermogravimetric analysis indicating the degradation onset temperature of this disclosure.

### DETAILED DESCRIPTION

This disclosure is directed to a method comprising pyrolytically modifying a biobased feedstock to remove at least a portion of the thermally labile components. Due to the removal of the thermally labile components and a concomitant increase in thermal stability, the resulting pyrolyzed biobased feedstock is well suited for subsequent use in melt processing applications with a polymeric matrix. Because the pyrolyzed biobased feedstock originates from a renewable source and is relatively inexpensive, the resulting article is generally less expensive than traditional synthetic polymers. In general, it has been discovered that biobased feedstocks that have not been treated in this manner may contain thermally labile components. During melt processing applications, the biobased feedstocks having thermally labile components can adversely affect the integrity and physical characteristics of the resulting composite material partly due to the decomposition or release of the thermally labile components. For example, extrusion of current biobased feedstocks with a polymeric matrix can result in weak materials or aesthetic properties that may not be desirable in some applications. The inventors have discovered that the pyrolytic modification of the biobased feedstock removes at least a portion of the thermally labile materials so as to increase the thermal stability making these materials very beneficial to subsequent melt processing of the material with a polymer matrix.

Biobased feedstocks are generally the co-products of renewable fuel processes. They are typically derived from grain-based agricultural materials that are used in wet or dry milling ethanol production facilities. Non-limiting examples of biobased materials used in fermentation processes in an ethanol production facility include grain crops such as corn, wheat, rye, barley, milo, sorghum, and the like. In certain embodiments, the biobased feedstock is the thin stillage from an ethanol, butanol or distilled spirits production facility. In other embodiments, the biobased feedstock is the evaporated product of thin stillage, also known by those of ordinary skill in the art as condensed distillers solubles and if dried to moisture levels at or below 15% they are generally known as dried distillers solubles. In some embodiments, dried distillers solubles are well suited for use as an additive in a polymer matrix. A process for making dried distillers solubles from thin stillage is disclosed in U.S. Pat. Publication No. 2013/0206034, herein incorporated by reference in its entirety.

In one embodiment, the biobased feedstock includes a distillers soluble stream generated from a wet or dry mill ethanol or distilled spirits facility processing a grain crop or any mixture of grain crops. For example, the distillers solubles stream may comprise: (a) material of which more than 25% of the total solids is soluble in water at a pH value of 3 to 4 and in some embodiments more than 50% of the total solids is soluble in water within the noted pH value range, and (b) an acid detergent fiber content less than 10%, 5%, 2% or 1% on a dry matter weight percentage basis. As will be appreciated by those skilled in the art, determination of the acid detergent fiber (ADF) content is in accordance with the ANKOM Tech. Method. The ANKOM Tech. Method analysis follows FD PROC 39, which is based on AOCS Ba 6a-05. In this method, a test sample is sealed in a small bag and the bag immersed in acetyl trimethyl ammonium bromide/sulfuric acid solution that dissolves certain materials such as, for example, hemicelluloses and cell wall proteins leaving behind celluloses, lignins, cutins, some pectins, and the like. The bag is then washed, dried and re-weighed. The loss in weight is reported as acid detergent fiber.

Those of ordinary skill in the art recognize that conventional techniques in ethanol processing may alter or modify the composition of the soluble stream. For purposes of this disclosure, such modifications are within the scope of this disclosure and the resulting soluble stream may be subjected to the method contemplated herein. For example, it is known in the art to utilize front-end and back-end fractionation practices that may alter a distillers solubles stream. Front-end fractionation is where a portion of the grain is removed prior to fermentation. Such portions removed may include fiber, protein, germ, and/or oil. Back-end fractionation can include known processing techniques such as oil recovery, fiber removal, protein concentration, protein isolate shifting such as washing protein from wet cake into distillers solubles to further enrich the distillers solubles with additional protein or materials. Additionally, filtration technology can also be used with various types of membrane processing. Furthermore, biobased feedstocks can be supplemented with other fermentable and non-fermentable products such as but not limited to sugars, starches, and food products that may impact the composition of the distillers solubles stream. In certain embodiments, the fermentation product shall be at least 25%, 50%, 75%, 90%, 95% and up to 100% agricultural grain or grains.

The pyrolytic modification of the biobased feedstock is intended to remove some or all of the thermally labile components without adversely impacting the remaining components of the feedstock. This is generally accomplished by rapid heating of the biobased feedstock. In some embodiments, the biobased material is heated to temperatures of about 170° C., 200° C., 225° C., 250° C., 275° C., and depending on the initial temperature, up to about 200° C., 250° C., 300° C., 350° C., or even 400° C., in a time frame less than two hours. In other embodiments, the heating may take place in less than one hour, less than thirty minutes, less than fifteen minutes, less than ten minutes, less than five minutes, less than one minute, or less than thirty seconds. Those of ordinary skill in the art will recognize that the time exposure and rapid heating convention will be dependent upon the particular biobased feedstock, the selected heating apparatus, and desired properties of the resulting material. In one embodiment, the pyrolytic modification of the biobased feedstock is achieved by heating at temperatures above 180° C. for a period of 10-60 minutes. In another embodiment, the temperature is above 220° C. for a period of 5-30 minutes. In another embodiment, the temperature is above 240° C. for a period of 5-30 minutes.

In various embodiments, the pyrolytic modification may utilize direct heating, indirect heating, steam, microwave, mechanical shear, extrusion, or a combination thereof. Additionally, the pyrolytic modification in some embodiments may occur in a continuous process. For example, a belt, conveyor, rotating drum or an extruder may be employed to pyrolytically modify the biobased feedstock in accordance with this disclosure. In other embodiments, it may be suitable to utilize air, inert gas, or at least a partial vacuum (e.g., greater than 0.001 but less than 1 atmosphere) during pyrolytic modification. In other embodiments, it may be suitable to utilize air or inert gas at pressures at 1 atmosphere or greater during pyrolytic modification. In other embodiments it may be suitable to utilize air or inert gas at pressures less than 0.7 mPa, less than 0.5 mPa, less than 0.3 mPa, less than 0.2 mPa, less than 0.1, mPa, or less than 0.05 mPa during pyrolytic modification. In other embodiments, a negative pressure or vacuum may be utilized. Those of ordinary skill in the art are capable of selecting specific processing equipment and operating conditions with a chosen biobased feedstock to achieve desired results.

Pyrolytic modification in an extruder is one particular embodiment well suited for creating a thermally stable biobased feedstock. Extruders with various heating zones and screw designs (conveying and mixing elements) enable the rapid heating necessary to achieve pyrolytic modification of the biobased feedstock. Single screw and twin screw extruders are all capable of attaining the desired pyrolytic modification. In some embodiments, the pyrolytic modification is performed using an extruder where at least some of the extruder zones are at temperatures above 180° C., above 220° C., 250° C., 275° C., 300° C. or above 350° C. The extruder screw speed in various embodiments may be between 5 and 1000 rpm or between 20 and 500 rpm. In some embodiments, the extruder pressure is below 70 mPa, 35 mPa, 7 mPa, 5 mPa, 1 mPa, or less than 0.5 mPa. In other embodiments, the heating may take place in the extruder for less than one hour, less than thirty minutes, less than fifteen minutes, less than ten minutes, less than five minutes, less than one minute, or less than thirty seconds. In some embodiments, the extruder contains one or more vents to allow gases to escape. In certain applications, co-rotating twin screw extruders are well suited to pyrolytically modify the biobased feedstock. In certain embodiments, the pyrolytic modification of the biobased feedstock in an extruder is prior to extrusion with a polymer matrix. In an alternative embodiment, the pyrolytic modification may occur in the presence of a polymer component or with a polymer matrix. Polymer matrices in this instance may include polyolefins.

The process of pyrolytically modifying the biobased feedstock may utilize other additives in the process to enhance the resulting material or improve the efficiency of the process. For example, a catalyst may be added to the biobased feedstock prior to pyrolytic modification. Non-limiting examples of catalysts include organic acids, inorganic acids, bases and peroxides.

Thermally labile components are removed from the biobased feedstock to impart thermal stability in the finished material. Thermally labile components are inorganic compounds, organic compounds or polymers that generally outgas and/or decompose at temperatures below conventional polymer melt processing temps. In some embodiments, the thermally labile components outgas and/or decompose at temperatures above 120° C. It has been discovered to be very desirable to remove at least a portion of such compounds in order to minimize defects that can be attributed to the thermally labile components during melt processing with a polymer matrix. For example, the presence of and decomposition and/or outgassing of these thermally labile components may negatively impact the melt or the finished product due to such phenomenon as off-gassing, discoloration, and melt defects.

For purposes of this disclosure, thermal stability indicates a material's ability to withstand conventional melt processing temperatures and conventional processing rates without a significant loss of mass due to thermal degradation. A loss of mass due to thermal degradation during melt processing may adversely affect either the process or the resulting physical and aesthetic properties of the finished composite may be considered significant by those of ordinary skill in the art.

In another embodiment, a thermogravimetric analysis (TGA) may be utilized as an indication of the presence of thermal stability in the pyrolyzed biobased feedstock. The TGA establishes a degradation onset temperature for a specific sample of pyrolyzed biobased feedstock. The pyrolyzed biobased feedstock has a degradation onset temperature greater than a non-pyrolyzed biobased feedstock from which the pyrolyzed biobased feedstock was formed. For certain embodiments, it is desirable to have the degradation onset temperature about equal to or greater than a selected melt processing temperature with less than five percent mass loss. In one embodiment, it is desirable to have less than one percent mass loss at the selected melt processing temperature. One method for determining thermal stability utilizing TGA involves heating the sample of material at a relatively slow rate (i.e., 10° C./min) from room temperature to temperatures beyond the degradation onset temperature.

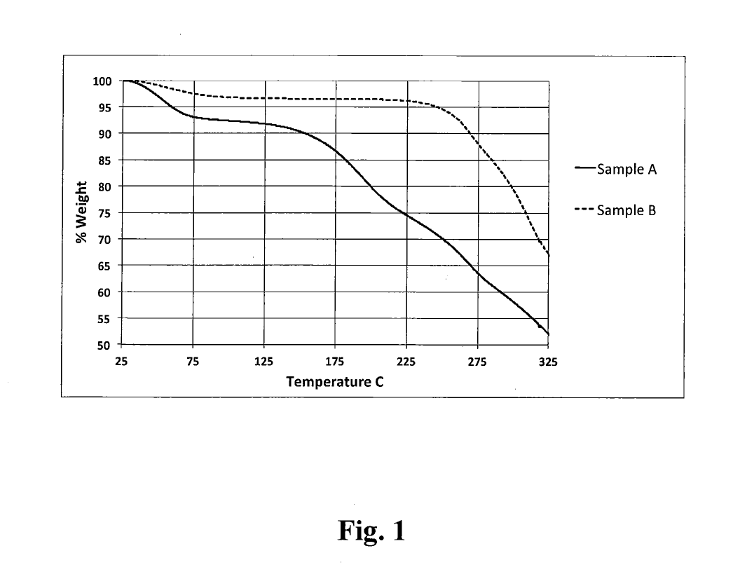

FIG. 1 depicts a graph of two samples of a biobased feedstock that were subjected to thermogravimetric analysis to determine the degradation onset temperature. Sample A was not subjected to the pyrolytic modification of this disclosure. Sample B is the same biobased feedstock of Sample A but pyrolytically modified to remove some of its thermally labile components. The degradation onset temperature is the point of inflection following the loss of moisture on the TGA curve. The moisture loss on sample A and sample B generally occurs between 25° C. and 125° C. With regard to Sample A, the moisture losses are about 7% when it reaches a degradation onset temperature of about 150° C. Sample B has a moisture loss of about 4% when it reaches a degradation onset temperature of about 250° C. The graphs of the TGA's are useful to determine the relative thermal stability of the materials.

In some embodiments, the pyrolyzed biobased feedstock of this disclosure is thermally stable at temperatures up to 350° C., 300° C., 280° C., 260° C., 240° C., 220° C., 200° C., or 180° C. with less than five percent loss of mass, not including moisture, as measured under the above noted TGA analysis at heating rate of 10° C./min. In other embodiments, the pyrolyzed biobased feedstock of this disclosure is thermally stable at temperatures up to 350° C., 300° C., 280° C., 260° C., 240° C., 220° C., 200° C., or 180° C. with less than two percent loss of mass, not including moisture, using TGA test parameters at heating rate of 10° C./min.

One particular enhancement resulting from pyrolytic modification of biobased feedstocks is the reduction of odor from the material. Biobased feedstocks generally have a very noticeable, and often undesirable odor. This may carry over through melt processing conditions and negatively impact the finished polymer. Various embodiments of pyrolyzed biobased feedstocks produced in accordance with this disclosure have a more favorable odor rating, or rather a lack of noticeable odor in comparison to biobased feedstocks that have not been pyrolytically modified.

An additional beneficial feature of pyrolytic modification is the reduction of thermally labile components. Non-limiting examples of thermally labile components include hemicellulose and carbohydrates. Certain embodiments have less than 10 wt % thermally labile components remaining after pyrolytic modification, not including moisture, at temperatures of less than 300° C., 250° C., 225° C. or less than 200° C. using the TGA analysis set forth in this disclosure. Other embodiments may have less than 5%, or less than 2%, thermally labile components remaining after pyrolytic modification, not including moisture, at temperatures less than 300° C., 250° C., 225° C. or less than 200° C. using the TGA analysis set forth in this disclosure.

In certain embodiments, the reduction of thermally labile components results in a pyrolyzed biobased feedstock that still retains desired components of its initial feedstock. The carbonization of the feedstock and a significant loss of mass resulting in low yields is not necessarily a desired outcome of pyrolytic modification. In some aspects, the mass loss after pyrolytic modification, not including moisture, is less than 75%, less than 60%, less than 50%, less than 40%, less than 30%, less than 25%, less than 20%, less than 15%, or even less than 10%. Those of ordinary skill in the art with knowledge of this disclosure will recognize that the initial form and composition of the biobased feedstock subjected to pyrolytic modification will have an impact on the expected mass loss and corresponding yields.

The pyrolyzed biobased feedstock is in a physical form well suited to serve as an additive for melt processing applications. The material may be in either granular or powder form with various particle sizes. The sizing of the particulates or powder may be selected to achieve the desired mixing with other components and thereby prevent segregation or other material handling issues. In one embodiment, the pyrolyzed biobased feedstock is milled to a particle size, such as for example, less than 500 microns, less than 300 microns, less than 100 microns, less than 50 microns, less than 25 microns, or less than 10 microns. Non-limiting examples of milling equipment useful for this purpose include cone mills, ball mills, jet mills and hammer mills. Those of ordinary skill in the art are capable of designating the specific sizing needed to address handling and mixing of the pyrolyzed biobased feedstock.

The enhanced thermal stability, reduced odor and other beneficial properties of the pyrolyzed biobased feedstock permit the use and application of the materials as additives in polymer composites formed through melt processing applications. Those of ordinary skill in the art are capable of combining the pyrolyzed biobased feedstock with various polymer matrices and other optional additives to achieve desired properties for a composite material. The pyrolyzed biobased feedstock may be included in final composite formulations in amounts of about 0.1-95% by weight, 0.1-75% by weight, 0.1-50% by weight, 0.1-25% by weight, 0.1-15% by weight and 0.1-10% by weight.

The polymer matrix functions as the host polymer and is a component of the melt processable composition. A wide variety of polymers conventionally recognized in the art as suitable for melt processing are useful as the polymeric matrix. They include both hydrocarbon and non-hydrocarbon polymers. Examples of useful polymeric matrices include, but are not limited to, polyamides, polyimides, polyurethanes, polyolefins, polystyrenes, polyesters, polycarbonates, polyketones, polyureas, polyvinyl resins, polyacrylates, polymethylacrylates, or combinations thereof.

The polymer matrix is included in the melt processable compositions in amounts of typically greater than about 75% by weight, 50% by weight, 40% by weight, or 30% by weight. Those skilled in the art recognize that the amount of polymeric matrix will vary depending upon, for example, the type of polymer, the amount of pyrolyzed biobased feedstock, the selected optional additives, the processing equipment, processing conditions and the desired end product.

In another aspect, the melt processable composition may contain other additives or adjuvants. Examples of conventional additives or adjuvants include, but are not limited to, antioxidants, light stabilizers, fibers, mineral fillers, catalysts, blowing agents, foaming additives, antiblocking agents, cross-linking agents, heat stabilizers, light stabilizers, viscosity stabilizers, moisture stabilizers, odor stabilizers, antistatic agents, impact modifiers, biocides, flame retardants, plasticizers, tackifiers, chain extenders, emulsifiers, colorants, processing aids, lubricants, coupling agents, pigments or combinations thereof. Those skilled in the art of melt processing are capable of selecting appropriate amounts and types of additives to match with a specific polymer matrix in order to achieve desired physical properties of the finished composite. In an alternative embodiment, it may be desirable to add one or more of these additives or adjuvants to the biobased feedstock prior to pyrolytic modification as opposed to after such modification.

The melt processable compositions may be prepared by any of a variety of ways using melt processing techniques. For example, the pyrolyzed biobased feedstock, any optional additives or adjuvants, and the polymer matrix can be combined together by any of the blending means usually employed in the plastics industry, such as with a compounding mill, a Banbury mixer, or a mixing extruder. The materials may be used in the form, for example, of a powder, a pellet, or a granular product. The mixing operation is most conveniently carried out at a temperature above the melting point or softening point of the polymer. The resulting melt-blended mixture can be either extruded directly into the form of the final product shape or pelletized or otherwise comminuted into a desired particulate size or size distribution and fed to an extruder that melt-processes the blended mixture to form the final product shape. Alternatively, the composition may be molded into a desired form. The resulting composite exhibits superior performance results when produced using this protocol.

Melt-processing typically is performed at a temperature from 120° C. to 300° C., and more typically between 150° C. and 250° C., although optimum operating temperatures are selected depending upon the melting point, viscosity, or thermal stability of the composition. Different types of melt processing equipment, such as extruders, may be used to process the melt processable compositions of this invention. In certain embodiments, twin screw extruders are well suited for melt mixing the components of the composite.

The resulting articles produced by melt processing the inventive composition exhibit superior mechanical characteristics in the field of composite structures. For example, a composite comprised of a pyrolyzed biobased feedstock may exhibit an increase in one or more characteristic, such as flexural modulus, flexural strength, tensile strength, tensile modulus and impact strength over composites with unmodified biobased feedstocks. In other embodiments, the incorporation of a pyrolyzed biobased feedstock at relatively high loading levels in a polymer matrix results in a composite without dramatic or significant change in physical characteristics over the neat polymer. The higher loading levels in the polymer matrix without the significant loss of physical properties can enable substantial economic benefit.

The composites of this invention are suitable for manufacturing articles in the construction, consumer goods and automotive industries. For example, articles incorporating the composition of the present invention may include: molded architectural products, forms, films, sheet, automotive parts, building components, or household articles.

### EXAMPLES

In Examples CE1 and 1-6, this example, samples of dried distillers solubles, derived from a corn fermentation process for renewable fuel and produced in accordance with U.S. Pat. Publication No. 2013/0206034, were pyrolytically modified using a commercially available moisture analyzer, Computrac MAX 5KXL, from Arizona Instruments (Chandler, Ariz.). The instrument was heated to a target temperature and 10 grams (g) of the sample were added to the unit and allowed to pyrolyze under a low vacuum pressure for the time indicated in Table 1. Comparative example (CE1) was not subjected to pyrolytic modification. The thermal stability of the resulting materials was determined by measuring percent mass loss of a 2-50 mg sample at a given temperature using a Mettler Toledo STAR 1 Thermogravametric Analysis (“TGA”) unit (Mettler-Toledo LLC, Columbus, Ohio). Also included in Table 2 is the degradation onset temperature after the examples were pyrolyzed at the specified conditions. All examples, including comparative example CE1, were characterized using the same temperature ramp profile (room temperature to 300° C. ramp at 10° C./min). The pyrolytic treatment conditions are summarized in Table 1, and thermal stability results including percent mass loss and degradation onset temperatures are given in Table 2.

TABLE 1
Conditions for Pyrolytic Treatment
of Biobased Feedstock Examples

| Example | Pyrolytic Treatment Conditions |
|---|---|
| CE1 | None |
| 1 | 180° C., 15 min |
| 2 | 180° C., 30 min |
| 3 | 200° C., 15 min |
| 4 | 200° C., 30 min |
| 5 | 220° C., 15 min |
| 6 | 220° C., 30 min |

In Table 2, the percent mass loss and degradation onset temperature is given for each of the pyrolytic treatments investigated.

TABLE 2
Mass Loss and Degradation Onset Temperature
for Pyrolyzed Biobased Feedstock Examples

| Example | Mass Loss (%) | Degradation Onset (° C.) |
|---|---|---|
| CE1 | 0 | 140 |
| 1 | 15.1 | 175 |
| 2 | 18.8 | 215 |
| 3 | 22.2 | 220 |
| 4 | 25.2 | 235 |
| 5 | 32.5 | 275 |
| 6 | 33.2 | 275 |

As can be seen from Table 2, the thermal stabilities for all of the pyrolyzed biobased feedstock examples 1-6 were markedly improved relative to the control CE1 as evidenced by the increase in the degradation onset temperature. Moreover, percent mass loss and degradation onset temperature generally increased as a function of increased temperature and exposure time.

In another embodiment, the pyrolytic modification in a twin screw extruder was examined Samples of the untreated dried distillers solubles used in the above examples were pyrolytically modified using a 36:1 L:D, co-rotating twin screw extruder commercially available from American Leistritz Corporation (Sommerville, N.J.). A flat temperature profile for all zones was utilized for each example. The temperature, screw speed and output for each example are listed in Table 3. The examples were extruded using open face profile (no die) onto a belt and collected. The resulting materials were characterized using the TGA method described above. Comparative example CE2 was not processed in the extruder whereas examples 7-15 were processed in the extruder at different temperatures and feed rates. Degradation onset temperatures of the examples are provided in Table 4.

TABLE 3
Twin Screw Extruder Modified Biobased Feedstock Examples

| Example | Temperature (C.) | RPM | Rate (lbs/hr) |
|---|---|---|---|
| CE2 | 0 | 0 | 0 |
| 7 | 200 | 30 | 2 |
| 8 | 220 | 30 | 2 |
| 9 | 240 | 30 | 2 |
| 10 | 240 | 75 | 4 |
| 11 | 240 | 100 | 8 |
| 12 | 260 | 75 | 4 |
| 13 | 260 | 100 | 8 |
| 14 | 260 | 200 | 16 |
| 15 | 280 | 400 | 32 |

TABLE 4
Degradation Onset Temperature for Pyrolyzed
Biobased Feedstock Examples

| Example | Degradation Onset (° C.) |
|---|---|
| CE2 | 140 |
| 7 | 170 |
| 8 | 175 |
| 9 | 185 |
| 10 | 180 |
| 11 | 180 |
| 12 | 190 |
| 13 | 185 |
| 14 | 195 |
| 15 | 195 |

As can be seen from Table 4, pyrolytic modification in a twin screw extruder was observed and provided improved thermal stability of the biobased feedstock as evidenced by the increased degradation onset temperatures relative to the control (CE2).

From the above disclosure of the general principles and the preceding detailed description, those skilled in this art will readily comprehend the various modifications to which the present method is susceptible. Therefore, the scope of the invention should be limited only by the following claims and equivalents thereof.

What is claimed is:

1. A method comprising pyrolytically modifying a biobased feedstock to remove at least a portion of a thermally labile component from the biobased feedstock to form a pyrolyzed biobased feedstock.

2. A method according to claim 1, wherein pyrolytically modifying the biobased feedstock comprises heating the biobased feedstock to a temperature within a range of greater than 170° C. to less than 350° C. for a period of time of less than 2 hours.

3. A method according to claim 1, wherein pyrolytic ally modifying the biobased feedstock comprises indirect heating, direct heating, steam, microwave, mechanical shear or extrusion.

4. A method according to claim 1, wherein pyrolytically modifying the biobased feedstock comprises a continuous process.

5. A method according to claim 4, wherein the continuous process for pyrolytic modification comprises feeding the biobased feedstock through a belt, rotary drum, a conveyor, or an extruder.

6. A method according to claim 1, wherein the pyrolyzed biobased feedstock is thermally stable in a subsequent melt processing step.

7. A method according to claim 1, further comprising introducing an inert gas during the pyrolytic modification of the biobased feedstock.

8. A method according to claim 1, wherein pyrolytically modifying the biobased feedstock is under a partial vacuum.

9. A method according to claim 1, further comprising adding a catalyst to the biobased feedstock during the pyrolytic modification.

10. A method according to claim 1, wherein the biobased feedstock is derived from corn, wheat, rye, barley, milo, or sorghum.

11. A method according to claim 1, wherein the biobased feedstock comprises thin stillage condensed distillers solubles, or dried distillers solubles.

12. A method according to claim 1, wherein the biobased feedstock comprises a distillers solubles stream having water soluble solids greater than 25% of total solids at a pH of 3 to 4, and an acid detergent fiber value of less than 10 percent by weight.

13. A method according to claim 1, wherein the pyrolyzed biobased feedstock has a degradation onset temperature greater than a non-pyrolyzed biobased feedstock from which the pyrolyzed biobased feedstock was formed.

14. A method according to claim 1, further comprising combining the biobased feedstock with a polymer component or a polymer matrix prior to pyrolytically modifying the biobased feedstock.

15. A method comprising:
(a) pyrolytically modifying a biobased feedstock to remove at least a portion of thermally labile components from the biobased feedstock to form a pyrolyzed biobased feedstock; and
(b) melt processing the pyrolyzed biobased feedstock with a polymer matrix.

16. A method according to claim 15, wherein the polymer matrix includes polyamides, polyimides, polyurethanes, polyolefins, polystyrenes, polyesters, polycarbonates, polyketones, polyureas, polyvinyl resins, polyacrylates and polymethylacrylates.

17. A method according to claim 15, further comprising additives and adjuvants, including antioxidants, light stabilizers, fibers, mineral fillers, catalysts, blowing agents, foaming additives, antiblocking agents, cross-linking agents, heat stabilizers, light stabilizers, viscosity stabilizers, moisture stabilizers, odor stabilizers, antistatic agents, impact modifiers, biocides, flame retardants, plasticizers, tackifiers, chain extenders, emulsifiers, colorants, processing aids, lubricants, coupling agents, pigments or combinations thereof.

18. A method according to claim 15, wherein the biobased feedstock is thin stillage, condensed distillers solubles or dried distillers solubles.

19. A composition comprising a pyrolyzed biobased feedstock that is thermally stable up to 180° C., 200° C., 220° C., 240° C., 260° C., 280° C., 300° C., or 350° C.

20. A composition according to claim 19, wherein the pyrolyzed biobased feedstock is derived from thin stillage, condensed distillers solubles or dried distillers solubles.

21. A composition comprising the pyrolyzed biobased feedstock of claim 19 and a polymeric matrix.

22. A composition according to claim 21, further comprising an additive or adjuvant including antioxidants, light stabilizers, fibers, mineral fillers, catalysts, blowing agents, foaming additives, antiblocking agents, cross-linking agents, heat stabilizers, light stabilizers, viscosity stabilizers, moisture stabilizers, odor stabilizers, antistatic agents, impact modifiers, biocides, flame retardants, plasticizers, tackifiers, chain extenders, emulsifiers, colorants, processing aids, lubricants, coupling agents, pigments or combinations thereof.

23. A process of forming an article, the process comprising: extruding an extrudate comprising a pyrolyzed biobased feedstock material and polymer matrix to form the article, wherein the pyrolyzed biobased feedstock has a degradation onset temperature greater than a non-pyrolyzed biobased feedstock from which the pyrolyzed biobased feedstock was formed.

24. The process of claim 23, further comprising adding an additive or adjuvant prior to or during the extruding, the additive or adjuvant comprising antioxidants, light stabilizers, fibers, mineral fillers, catalysts, blowing agents, foaming additives, antiblocking agents, cross-linking agents, heat stabilizers, light stabilizers, viscosity stabilizers, moisture stabilizers, odor stabilizers, antistatic agents, impact modifiers, biocides, flame retardants, plasticizers, tackifiers, chain extenders, emulsifiers, colorants, processing aids, lubricants, coupling agents, pigments or combinations thereof.

25. The process of claim 23, wherein the pyrolyzed biobased feedstock material comprises a non-distillate product of a corn to ethanol fermentation process.

26. The process of claim 25, wherein the non-distillate product of the corn to ethanol fermentation process is dried distillers solubles having a moisture content of less than 15 percent by weight.

27. The process of claim 25, wherein the non-distillate product of the corn to ethanol fermentation process is condensed distillers solubles.

28. The process of claim 23, wherein the pyrolyzed biobased feedstock material comprises distillers solubles having water soluble solids greater than 25% of total solids at a pH of 3 to 4, and an acid detergent fiber value of less than 10 percent by weight.

29. The process of claim 23, wherein extruding the pyrolyzed biobased feedstock and the at least one melt processable polymer is at a temperature greater than 170° C. to less than 350° C.

30. The process of claim 23, wherein the degradation onset temperature of the pyrolyzed biobased feedstock is greater than 175° C.

31. The process of claim 23, wherein the pyrolyzed biobased feedstock comprises 0.1 to 95 percent of the extrudate.
